(19) United States
(12) Patent Application Publication
(10) Pub. No.: US 2003/0201677 A1
(43) Pub. Date: Oct. 30, 2003

(54) STEP MOTOR WITH MULTIPLE STATORS

(76) Inventors: Chang-Yung Feng, Taipei City (TW); Hung-Tse Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,109

(22) Filed: Dec. 19, 2002

(30) Foreign Application Priority Data
Apr. 25, 2002 (TW) 091108594

(51) Int. Cl. H02K 37/00

(52) U.S. Cl. 310/49 R

(57) ABSTRACT

A step motor includes a rotor and two stators. The two stators are installed around the rotor, having magnetic poles in different numbers to generate different step angles.

### BACKGROUND OF THE INVENTION

1. Field of the Invention

The invention relates to a step motor, and more particularly, to a step motor with multiple stepping angles to simultaneously achieve the goal of high rotational speed and high precision.

2. Description of the Prior Art

A motor is an indispensable power-transformation device in industry and the information society that is capable of transforming electrical power into kinetic energy. Motors that are in common use include DC-motors, AC-motors, and step motors. The former two are generally adopted in devices in which high precision is not required, such as in electric fans. Step motors are utilized in devices in which high precision control is required since their angular displacement and rotational speed can be managed with electric power by a controlling system. Therefore, step motors are utilized in devices demanding high-precision control, like a step motor driving the movement of a scanner module in a scanner. As digital information products are rapidly developing, step motors are commonly used in control systems of digital products to achieve positions and speeds required of digital appliances.

Variable reluctance motors and permanent magnet motors are the two most common types of step motors. Since permanent magnet motors are efficient in periods of discrete operation, the operating principles of common motors exemplified by a permanent magnet motor are described below.

Please refer to FIG. 1, which is a schematic diagram of a prior art step motor 10. The step motor 10 includes a rotor 12 and a stator 14. The stator 14 surrounds and is fixed outside the rotor 12, whereas the rotor 12 can rotate on a spindle. The rotor 12 is a permanent magnetic, comprising 6 magnetic north poles R1 to R6 equally distributed within the rotor 12 with each pole separated by 60 degrees from the adjacent poles. The stator 14 comprises 8 magnetic poles L1 to L8 formed by coils A and B coiled around electromagnets M1 to M8, and each magnetic pole is separated by 45 degrees from the adjacent poles. The polarity of each magnetic pole is decided by the rotation direction of the coil A or B, and the voltage polarity in the coil A or B.

The step motor 10 in this example comprises two sets of coils A and B. Coil A is wrapped around magnetic poles L1, L3, L5, and L7. Each magnetic pole L1, L3, L5, and L7 is different from each other in their coiling directions in order to generate different magnetic poles while applying electric charges. Similarly, coil B is wrapped around magnetic poles L2, L4, L6, and L8 in a manner comparable to the magnetic poles wrapped by coil A. A controller 16 is included in the step motor 10 and is electrically connected to coils A and B to control the current flowing through coils A and B and implicitly control the rotational speed of the rotor 12 in the step motor 10.

During a certain period of time when the coil A is conducting but the coil B is not conducting, one end of the electromagnets M1, M5 facing the rotor 12 become magnetic south poles. The L1, L5 poles of the stator 14 attract the R1, R4 poles of the rotor 12 respectively, and make the L1, L5 polar coils face the R1, R4 poles. Now the R2, L2 and the R5, L6 are both 15° counter clockwise separated from each other and the R3, L4 and the R6, L8 are both 15° clockwise separated from each other. The R6, L7 are 30° counter clockwise separated from each other.

In another period of time when the coil B is conducting but the coil A is not conducting, the ends of the electromagnets M2, M6 facing the rotor become magnetic south poles. The L2 pole and the L6 pole of the stator 14 attract the R2 and R5 poles of the rotor 12 which makes the rotor 12 counter rotate clockwise 15° and makes the L2 and L6 poles directly face the R2 and R5 poles respectively.

If the coil A is conducting once again, the ends of the electromagnets M3, M7 become magnetic south. The electromagnets M3, M7 of the stator 14 attract the R3, R6 poles of the rotor 12, the rotor 12 rotates counter clockwise 15°, and makes the electromagnets M3, M7 directly face the R3, R6 poles of the rotor 12.

It follows, if sequentially making the polarities of the ends facing the rotor 12 of the electromagnets M4, M8, the electromagnets M1, M5 and the electromagnets M2, M6 appear to be magnetic south poles, then the rotor 12 rotates counter clockwise with a stepping angle of 15°. The faster the current in the coils A and B changes, the faster the rotor 12 rotates. Notice that the stepping angle does not change, and a reversal of rotational direction can be achieved merely by altering the current direction.

The above mentioned is the operational principle of each step that the step motor 10 rotates. Of course, the step motor 10 can rotate a half step or a quarter step too, and the principles are mentioned below.

To control the step motor 10 to rotate a half or a quarter step, electric charges can be applied to the coils A and B, and make the sides of two adjacent magnets facing the rotor 12 become magnetic south. For example, applying electric charges to coils A and B simultaneously makes the ends of the electromagnets M2, M3 and the electromagnetic M6, M7 become magnetic south. However, the currents applied into coils A and B does not need to be the same. For example, if coil B is applied with a larger current, then the magnetic south poles of the electromagnets M2, M6 have a stronger polarity then those of the electromagnets M3, M7, and the rotor 12 rotates counter clockwise slightly. Therefore, adjusting the current differences between two coils can control the step motor 10 to rotate a half, a quarter, or other micro steps.

Please refer to FIG. 2, which is a lateral view of the step motor 10 in FIG. 1. The step motor 10 comprises a transmission shaft 18 fixed between the rotor 12 and an external gear wheel, which is for transmitting angular kinetic energy from the rotor 12 to the gear wheel 20. The wheel gear 20 is connected to an external output device to drive the external output device.

Although the step motor 10 can rotate a half or a quarter step by controlling the input current, it is still not possible to precisely control the rotor 12 by magnetic force. Deviation in several factors like the weight of the rotor, the weight of the output device, the precision of the controlling current, and any other related deviations all deteriorate the precision of the whole system. For example, a normal step motor has a 7% deviation when rotating a step, a 30% deviation when rotating half a step, and even worse when rotating a quarter step. Therefore, step motor 10 is not suitable when precise control is required.

Certainly, increasing the quantity of N-poles and S-poles of the rotor 12 and the stator 14 in the step motor 10 can reduce the rotating deviation because the step motor 10 can rotate a full step instead of a half or a micro step. However, a drawback of not being able to reach a high rotational speed then occurs since the rotation of the rotor 12 is controlled by current in the coils A and B, and the faster the current changes, the faster the rotor 12 rotates. Due to the limitation of the response time between the magnetic poles and the electromagnets, it is hard for the current in the coils A and B change rapidly. Therefore, if the stepping angle of the motor 10 is too small, the step motor 10 cannot reach high rotating speeds.

As above mentioned, the prior art step motor 10 can not meet both demands of high precision and high rotating speed simultaneously. In general devices, motive systems usually require both the characteristics of high precision and high rotating speed. However, the prior art step motor 10 can only supply one or the other.

### SUMMARY OF THE INVENTION

It is therefore a primary objective of the claimed invention to provide a step motor with multiple stepping angles to meet both demands of high precision and high rotating speed simultaneously.

The claimed step motor includes a rotor and two stators. The two stators are installed around the rotor, having magnetic poles in different numbers to generate different step angles. The stators can be operated individually or in unison to provide a wide variety of rotational speeds and precision.

A major advantage of the claimed invention is the ability to use one of the stators with a larger number of magnetic poles to achieve precise rotational angles or to use the other stator with a smaller number of magnetic poles to achieve high rotational speed within a single step motor.

### BRIEF DESCRIPTION OF DRAWINGS

FIG. 1 is a schematic diagram of a step motor according to prior art.

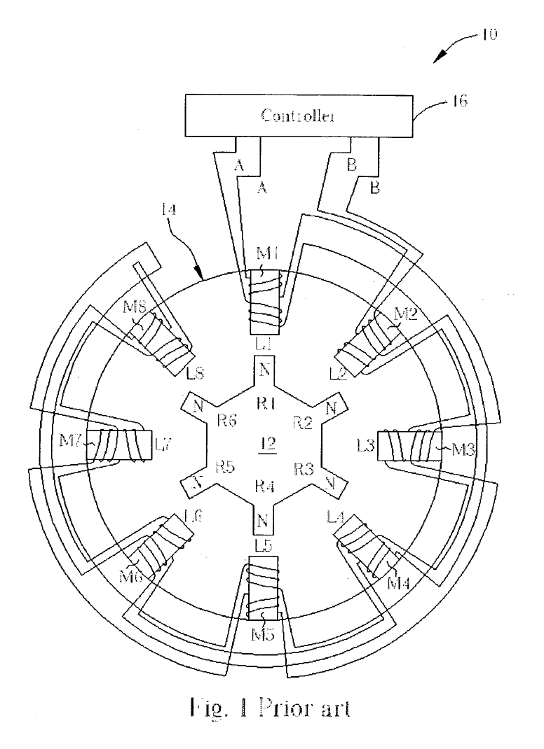

FIG. 2 is a lateral view of the step motor in FIG. 1.

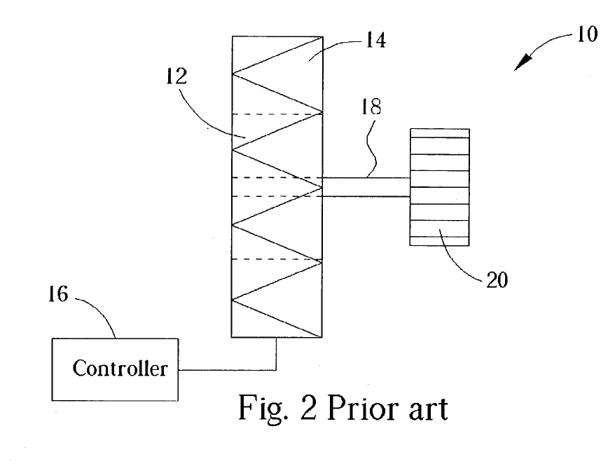

FIG. 3 is a schematic diagram of a step motor according to the present invention.

FIG. 4 is a front view of a first stator of the step motor in FIG. 3.

FIG. 5 is a front view of a second stator of the step motor in FIG. 3.

FIG. 6 is a schematic diagram of a scanner according to the present invention.

### DETAILED DESCRIPTION

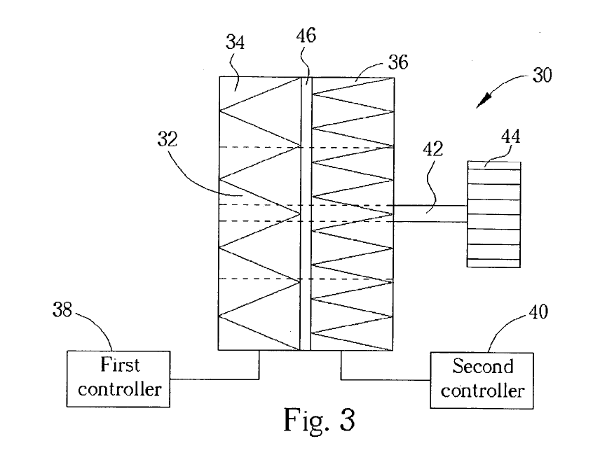

Please refer to FIG. 3, which is a lateral view of the step motor 30 according to the present invention. The step motor 30 is a permanent magnetic motor comprising a rotor 32, a first stator 34, a second stator 36, a first controller 38, and a second controller 40. The rotor 32 can rotate with a fixed spindle; the first stator 34 and the second stator 36 are fixed outside the rotor 32. The first controller 38 is for controlling the current in the coil of the first stator 34 to rotate the rotor 32. The second controller 40 is for controlling the current in the coil of the second stator 36 to rotate the rotor 32. The rotor 32 can therefore be rotationally driven by both the first stator 34 and the second stator 36.

The step motor 30 further comprises a spindle 42 connected between the rotor 32 and a gear wheel 44, to transmit the angular kinetic energy from the rotor 32 to the gear wheel 44. The gear wheel 44 is connected to an output device to drive the output device. A metal sheet is utilized between the first stator 34 and the second stator 36 to separate the magnetic line generated by the first stator 34 and the second stator 36 in order to avoid magnetic induction between the first stator 34 and the second stator 36.

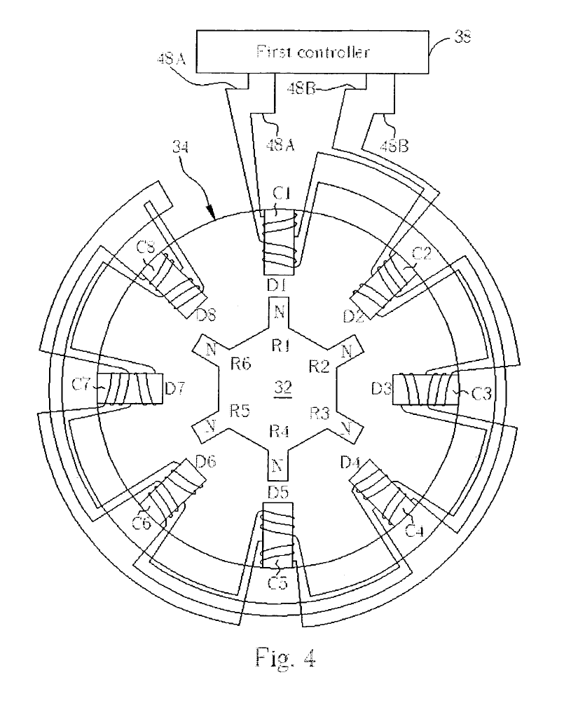

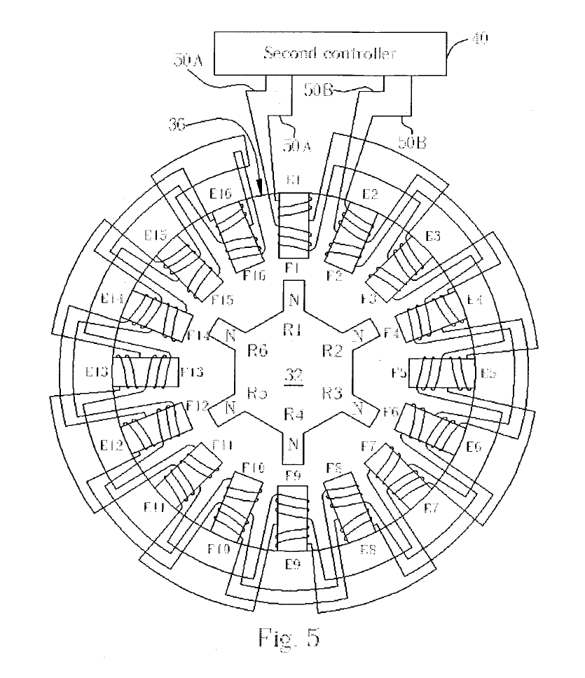

Please refer to FIG. 4 and FIG. 5. FIG. 4 is a front view of the first stator 34 in FIG. 3 according to the present invention. FIG. 5 is a front view of the second stator 36 in FIG. 3. The structures of the first stator 34 and the second stator 36 are similar to a prior art stator. The first stator 34 comprises a plurality of magnetic poles D1 to D8 formed by electromagnets C1 to C8 that are encircled by coils 48A and 48B. The first controller 38 for controlling the rotor 32 adjusts current flowing in coils 48A and 48B. The second stator 36 comprises a plurality of magnetic poles F1 to F16 formed by electromagnets E1 to E16 encircled by coils 50A and 50B. The second controller 40 adjusts current flowing in coils 50A and 50B to control the rotor 32. The second stator 36 has more magnetic poles than the first stator 32 does, and the ratio of magnetic poles owned by the second stator 36 to the first stator 34 is an integer; therefore, the first stator 34 has a larger stepping angle than the second stator 36 when driving the rotor 32.

The rotor 32 is driven by the first stator 34 and the second stator 36 and the stepping angle that the first stator 34 drives the rotor 32 is larger than the second stator 36. Therefore, the first stator 34 operates when the step motor 30 needs to rotate at a high speed, and on the other hand, the second stator 36 operates when the step motor 30 needs to rotate precisely.

As for deciding the quantity of the electromagnets Cᵢ of the first stator 34 and Eᵢ of the second stator 36, the demanding stepping angle should be taken into consideration. If the external gear wheel 44 of the step motor 30 has a separation angle of 7.5° for each gear tooth, then the stepping angle of the first stator 34 can be a double of 7.5°, which is 15°. The stepping angle for the second stator 36 can be half of 7.5°, which is 3.75°. Therefore, to rotate the step motor 30 half a gear tooth (3.75°), it can be achieved by driving the rotor 32 with the second stator 36 rotating one full step instead of the half step required in the prior art. The full step of the present invention results is less deviation than the half step of the prior art and is therefore preferable for precision control.

A conventional step motor 30 has a deviation of 7% when rotating a full step and 30% when rotating a half step which implies that by utilizing the step motor 30, the deviation can be decreased from 30% to 7%, greatly increasing the precision of the gear wheel 44. Similarly, if a gear wheel needs to rotate at a high speed, the step motor 30 can drive the rotor 32 with the first stator 34 of which the stepping angle is 15°. When the current in coils 48A and 48B of the first stator 34 changes direction once, the rotor 32 can rotate 15°. The prior art stator 14 with a stepping angle of 7.5° needs to change the current direction twice for the rotor 12 to rotate 15°. Therefore, if the response time of current changing direction of the present art equals that of the prior art, then the present invention rotor 32 can rotate at double the speed of the prior art. Therefore, the step motor 30 according to the present invention can achieve both high rotational speed and high precision by controlling the rotor 32 with the first stator 34 and the second stator 36.

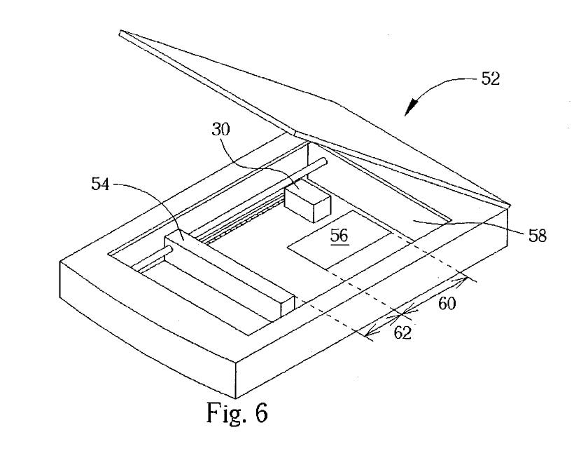

Please refer to FIG. 6, which is a schematic diagram of a scanner according to the present invention. Take a scanner module 54 in a scanner 52 as an example. The scanner module 54 is utilized in the scanner 52 for scanning the document 56 by moving forward and backward, and the step motor 30 drives the scanner module. The document 56 is placed on a scan area 60 of a scanner platform 58, and a transitional area 62 needs to be passed before the scanner module 54 reaches the scan area 60.

The step motor 30 can drive the rotor 32 with the first stator 34 to make the scanner module 54 pass the transitional area 62 at high speed to the scan area 60, in order to save time wasted in passing the transitional area. When the scanner module enters the scan area 60, the step motor 30 then drives the rotor 32 with the second stator 36 to make the rotor 32 scan the document 56 at smaller stepping angles, which results in high precision and a higher resolution. The step motor 30 according to the present invention can be applied into other electronic devices as well, like a printer; the step motor 30 according to the present invention can control the motion of the printhead of the printer.

Besides, the phases of the first stator 34 and the second stator 36 do not need to be coupled, since the step motor 30 can take advantage of only the first controller 38 or the second controller 40 to control the rotor 32. Certainly, the quantity of the electromagnets Cᵢ of the first stator 34 can equal that of the second stator 36; such design is needed in devices where a high torque is required. In this design, the corresponding currents in the magnetic poles of the first stator 34 and the second stator 36 are conducted simultaneously to drive the rotor 32 at the same time, which results in a higher torque.

In contrast to the prior art, the present invention calibration method comprises at least two stators 34 and 36 to drive the rotor 32. The stepping angle of the first stator 34 is larger, which is for driving the rotor 32 at a high speed; and the stepping angle of the second stator 36 is smaller, which is for driving the rotor 32 with high precision. Therefore, the step motor 30 according to the present invention can simultaneously meet the demands of high-speed rotation and high precision. Of course, the number of the stators is not restricted to two, it can be added conditionally.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A step motor comprising:
a rotor; and
two stators installed around the rotor, each stator having a different number of magnetic poles in order to generate different step angles.

2. The step motor of claim 1 further comprising a partition device installed between the two stators for preventing electromagnetic induction generated between the two stators.

3. The step motor of claim 1 further comprising a first control circuit and a second control circuit for respectively controlling current transmitted to each of the two stators.

4. The step motor of claim 1 wherein phases of the two stators match, and the two stators are capable of sequentially conducting electricity so as to sequentially induce the rotor to rotate.

5. The step motor of claim 1 wherein phases of the two stators do not match.

6. The step motor of claim 1 being a permanent magnetic motor.

7. The step motor of claim 1 being used to drive a module element of an electronic device.

8. The step motor of claim 7 wherein the electronic device is a scanner and the module element is a scanning module.

9. The step motor of claim 7 wherein the electronic device is a printer.
